(19) United States
(12) Patent Application Publication
(10) Pub. No.: US 2019/0345333 A1
(43) Pub. Date: Nov. 14, 2019

(54) POLYMER BLEND CONTAINING POLYCARBONATE AND POLYSULFONE FOR COMPOSITE

(71) Applicant: COREX MATERIALS CORPORATION, Taichung City (TW)

(72) Inventors: Pierre Coat, Taichung City (TW); Shao-Chen Chiu, Taichung City (TW)

(21) Appl. No.: 15/978,525

(22) Filed: May 14, 2018

(51) Int. Cl. C08L 81/06; C08J 5/04; C08L 69/00

(52) U.S. Cl. CPC C08L 81/06; C08L 69/00; C08J 5/04

(57) ABSTRACT

A polymer blend containing polycarbonate and polysulfone in accordance with an embodiment of the present invention is provided, including a polysulfone resin, a polycarbonate resin, and a solvent for dissolving the polysulfone resin and the polycarbonate resin. The blending ratio of the polycarbonate resin to the polysulfone resin in the polymer blend ranges from 1:3 to 3:1. By adjusting the blending ratios of the polycarbonate resin to the polysulfone resin, the group of the polycarbonate resin and the group of the polysulfone resin are stably compatible with each other, and the glass transition temperature of the polymer blend is also remarkably increased, such that the a high-temperature resistance and improved mechanical properties are achieved.

### BACKGROUND OF THE INVENTION

### 1. Field of the Invention

The present invention relates to a thermoplastic polymer blend, and more particularly, to a polymer blend containing polycarbonate and polysulfone.

### 2. Description of the Related Art

Polycarbonate material has several mechanical properties, such as outstanding tensile strength and impact resistance. Also, polycarbonate material possesses excellent heat resistance and optical transparency. Therefore, polycarbonate material is broadly applied to various fields of industries.

Moreover, for improving the high-temperature resistance and mechanical properties of the polycarbonate material, a polymer blend containing the polycarbonate is prepared by the industry. A polycarbonate-polyorganosiloxane copolymer, a preparing method thereof, and a polycarbonate resin containing the polycarbonate-polyorganosiloxane copolymer are disclosed in TW patent 1572637. By experimentally adjusting an optimal concentration ratios between polycarbonate and polyorganosiloxane, the copolymer with consistent impact resistance upon polyorganosiloxane is prepared. Also, the stability of high-temperature resistance of the copolymer is further enhanced.

However, the mechanical property of the polycarbonate is unable to be improved by the copolymer made of polycarbonate-polyorganosiloxane, due to the polyorganosiloxane being lack of the physical property of high mechanical strength.

Therefore, the present invention performs a modification of the polycarbonate and polysulfone to make them be miscible with each other, wherein, the polysulfone, which is a thermoplastic polymeric material, is provided with excellent mechanical strength and stable high-temperature resistance. Therefore, the blend containing polycarbonate and polysulfone thereby prepared has a high-temperature resistance and improved mechanical property.

### SUMMARY OF THE INVENTION

For improving the issues above, a polymer blend containing polycarbonate and polysulfone is provided. By preparing different blending ratios of the polycarbonate to the polysulfone in the polymer blend, the group of the polycarbonate resin and the group of the polysulfone resin are miscible with each other. As a result, the glass transition temperature of the polymer blend containing polycarbonate and polysulfone is significantly increased compared to the polycarbonate, and the high-temperature resistance and improved mechanical property are further achieved.

In an embodiment of the present invention, a polymer blend containing polycarbonate and polysulfone is provided, comprising a polysulfone resin, a polycarbonate resin, and a solvent dissolving the polysulfone resin and the polycarbonate resin, wherein a blending ratio of the polycarbonate resin to the polysulfone resin in the polymer blend ranges from 1:3 to 3:1; and the blending solvent is a polar aprotic solvent such as, but not limited to, N-methyl pyrrolidone, dimethyl sulfoxide, dimethyl acetamide, dimethyl formamide, cyclopentanone, dichloromethane, and a mixture thereof.

Therefore, by effectively adjusting different blending ratios of the polycarbonate resin to the polysulfone resin in the polymer blend, groups of the polycarbonate resin and the groups of the polysulfone resin are stably compatible. Also, the glass transition temperature of the blend containing polycarbonate and polysulfone is significantly increased, and the high-temperature resistance and improved mechanical property are further achieved.

### BRIEF DESCRIPTION OF THE DRAWINGS

FIG. 1 is a curve graph of a glass transition temperature of a polymer blend containing polycarbonate and polysulfone in accordance with an embodiment of the present invention, illustrating the analysis of the glass transition temperature of different blending ratios of the polycarbonate resin to the polysulfone resin in the polymer blend.

FIG. 2 is a bar graph of a flexural modulus of the blend containing polycarbonate and polysulfone in accordance with the embodiment of the present invention, illustrating the test of the flexural modulus of different blending ratios of the polycarbonate resin to the polysulfone resin in the polymer blend.

FIG. 3 is a bar graph of a flexural strength of the blend containing polycarbonate and polysulfone in accordance with the embodiment of the present invention, illustrating the test of the flexural strength of different blending ratios of the polycarbonate resin to the polysulfone resin in the polymer blend.

### DETAILED DESCRIPTION OF THE INVENTION

The aforementioned and further advantages and features of the present invention will be understood by reference to the description of the preferred embodiment in conjunction with the accompanying drawings where the components are illustrated based on a proportion for explanation but not subject to the actual component proportion.

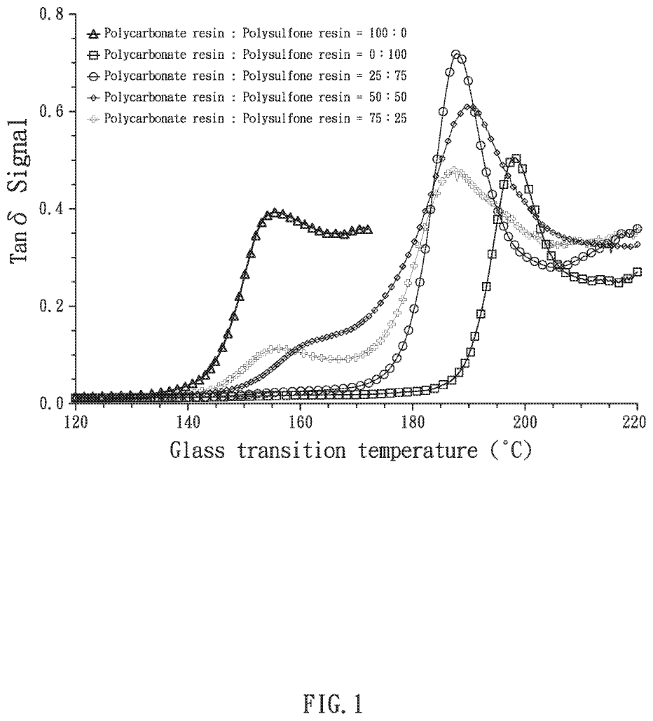

Referring to FIG. 1 to FIG. 3, a polymer blend containing polycarbonate and polysulfone in accordance with an embodiment of the present invention is provided, comprising a polysulfone resin, a polycarbonate resin, and a solvent dissolving the polycarbonate resin and the polysulfone resin.

The blending ratio of the polycarbonate resin to the polysulfone resin in the polymer blend ranges from 1:3 to 3:1, and the total weight of the polycarbonate resin and the polysulfone resin accounts for 20% to 60% of the weight of the overall polymer blend. In an embodiment of the present invention, the total weight of the polycarbonate resin and the polysulfone resin account for 40% of the weight of the overall polymer blend; the total solid content of the polycarbonate resin and the polysulfone resin ranges from 30% to 40% of the overall polymer blend, wherein the solvent is a polar aprotic solvent such as, but not limited to, N-methyl pyrrolidone (NMP), dimethyl sulfoxide (DMSO), dimethyl acetamide (DMAC), dimethyl formamide (DMF), cyclopentanone, dichloromethane, and a combination thereof.

The preparing method of the polymer blend in accordance with the embodiment of the present invention includes heating the solvent in a container and slowly adding the polymer while agitating the solvent; heating the mixture to 60° C. and continuing to heat and stir. The blending ratio of the polycarbonate resin to the solvent, and the blending ratio of the polysulfone resin to the solvent are both ranging from 1:4 to 2:3. The polycarbonate resin and the polysulfone resin are dissolved in the solvent, respectively, so as to form a polycarbonate resin solution and a polysulfone resin solution.

Table 1 is a proportioning parameter table showing the proportion of the polycarbonate resin and the solvent. The solvent is N-methyl pyrrolidone (NMP), and the solvation temperature is 60° C.

TABLE 1

| | | | |
|---|---|---|---|
| Polycarbonate resin | 800 | 1200 | 1600 |
| (g) | | | |
| Solvent (g) | 3200 | 2800 | 2400 |
| Blending ratio | 1:4 | 3:7 | 2:3 |
| Solid content | 20% | 30% | 40% |

Table 2 is a proportioning parameter table showing the proportion of the polysulfone resin and the solvent. The solvent is N-methyl pyrrolidone (NMP), and the solvation temperature is 60° C.

TABLE 2

| | | | |
|---|---|---|---|
| Polysulfone resin (g) | 800 | 1200 | 1600 |
| Solvent (g) | 3200 | 2800 | 2400 |
| Blending ratio | 1:4 | 3:7 | 2:3 |
| Solid content | 20% | 30% | 40% |

As shown in Table 1 and Table 2, it is proved by experiments that when the blending ratio of the polycarbonate resin or polysulfone resin to the solvent is 1:4, the solid content of the polycarbonate resin or polysulfone resin in the polycarbonate resin solution or polysulfone resin solution accounts for 20% of the overall polycarbonate resin solution or polysulfone resin solution. In other words, when the blending ratio of the polycarbonate resin or polysulfone resin to the solvent is 2:3, the solid content of the polycarbonate resin or polysulfone resin in the polycarbonate resin solution or polysulfone resin solution is 40%. In a preferred embodiment of the present invention, the blending ratio of the polycarbonate resin to the solvent, and the blending ratio of the polysulfone resin to the solvent are both 3:7; the solid content of the polycarbonate resin in the polycarbonate resin solution and the polysulfone resin in the polysulfone resin solution are both 30%.

For inquiring the most preferred proportioning parameter of the blending of the polycarbonate resin and the polysulfone resin, the experiment prepares the blending ratios of the polycarbonate resin solution to the polysulfone resin solution into 1:3, 1:1 and 3:1, respectively, and the pure polycarbonate resin solution and the pure polysulfone resin solution are taken as two control groups.

Table 3 is a proportioning parameter table showing the blending ratio of the polycarbonate resin and the polysulfone resin.

TABLE 3

| | | | | | |
|---|---|---|---|---|---|
| polycarbonate | 0 | 75 | 150 | 225 | 300 |
| resin (g) | | | | | |
| polysulfone | 300 | 225 | 150 | 75 | 0 |
| resin (g) | | | | | |
| Blending | only | 225:75 | 50:50 | 75:25 | only |
| ratio | polysulfone | (1:3) | (1:1) | (3:1) | polycarbonate |
| | resin | | | | resin |

Next, a fiber reinforcement is dipped in the polycarbonate resin solution and the polysulfone resin solution that consist of different ratios of the polycarbonate resin to the polysulfone resin. In an embodiment of the present invention, the fiber reinforcement is made of a carbon fiber material. A thin film of the polycarbonate resin, or the polysulfone resin, or the combination thereof is formed on the surface of the dipped fiber reinforcement. Then, the dipped fiber reinforcement is placed in an environment with a temperature from 170° C. to 300° C., so as to be solidified for 2 minutes and dry the thin film. In the embodiment of the present invention, the dipped fiber reinforcement is heated up to 220° C. to be dried and solidified.

Afterward, several layers of the impregnated fabric are stacked-up and pressed at a temperature of 260° C. and a pressure of 6 MPa to form a laminated composite.

Subsequently, the flexural modulus and the flexural strength of the composite are tested by ASTM (American Society for Testing and Materials). Also, the glass transition temperature of the copolymer containing the polycarbonate resin and the polysulfone resin is analyzed by use of a Dynamic Mechanical Analyzer (DMA).

Table 4 is a comparison table showing glass transition temperatures of the copolymers with different blending ratios of the polycarbonate resin to the polysulfone resin.

TABLE 4

| | | |
|---|---|---|
| ratio of | | |
| polycarbonate resin | | |
| to polysulfone resin | | |
| in the copolymer | Tg1 (° C.) | Tg2 (° C.) |

| | |
|---|---|
| 100:0 | 155.1 |

| | | |
|---|---|---|
| 75:25 | 155.7 | 187.0 |
| 50:50 | 160.9 | 189.9 |
| 25:75 | 187.9 | |

| | |
|---|---|
| 0:100 | 197.9 |

Referring to FIG. 1 and Table 4, it is shown in the experiment that the glass transition temperature of the polysulfone resin solution is up to 198° C., and the glass transition temperature of the polycarbonate resin solution is 155° C. Moreover, Tan δ signals of the glass transition temperature are detected when the blending ratio of the polycarbonate resin to the polysulfone resin in the polymer blend are 50:50(1:1) and 75:25(3:1), respectively. However, only one Tan δ signal of the glass transition temperature is detected when the blending ratio of the polycarbonate resin to the polysulfone resin in the polymer blend is 25:75(1:3).

Specifically, when the temperature of a polymer reaches up to the glass transition temperature, the long chain molecules in the polymer possess fluidity, which softens the structure of the polymer. Also, a single polymer presents only one signal glass transition temperature.

Moreover, when two kinds of polymers are blended, three results are possibly acquired:

1. When the two polymers are immiscible and completely separate from each other, the force of the molecular interaction between two kinds of the polymers does not exist, such that two signals of the glass transition temperature are presented.

2. When two kinds of the polymers are partially miscible, and the force of the bonding interaction between two kinds of the polymers are partially retained, two signals of the glass transition temperature are presented, wherein the signal values are between the glass transition temperature signals of the two polymers. Also, when two kinds of the polymers being more miscible with each other, the two glass transition temperature signals of the two polymers are closer to each other.

3. When the two polymers are completely miscible, only one signal of the glass transition temperature is presented.

Obviously, when the blending ratios of the polycarbonate resin to the polysulfone resin in the polymer blend are 50:50(1:1) and 75:25(3:1), respectively, the polycarbonate resin and the polysulfone resin are partially miscible. Comparatively, when the blending ratio of the polycarbonate resin to the polysulfone resin in the blend is 25:75(1:3), the polycarbonate resin and the polysulfone resin are stably miscible.

Table 5 is a comparison table illustrating the flexural modulus and the flexural strength of the composite with different blending ratios of the polycarbonate resin to the polysulfone resin in the polymer blend, respectively.

| ratio of the | | |
|---|---|---|
| polycarbonate resin | | |
| to polysulfone resin | Flexural modulus | Flexural strength |
| in the copolymer | (GPa) | (MPa) |
| 100:0 | 53.1 | 789 |
| 75:25 | 50.4 | 659 |
| 50:50 | 50.2 | 829 |
| 25:75 | 56.1 | 780 |
| 0:100 | 60.4 | 950 |

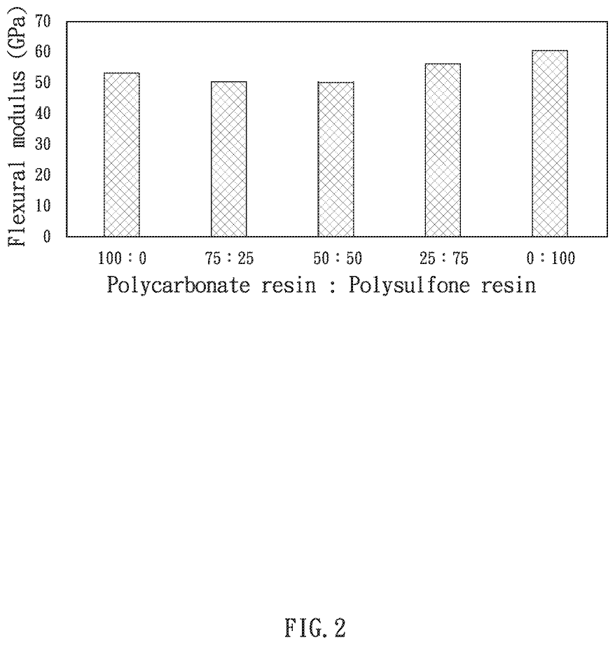

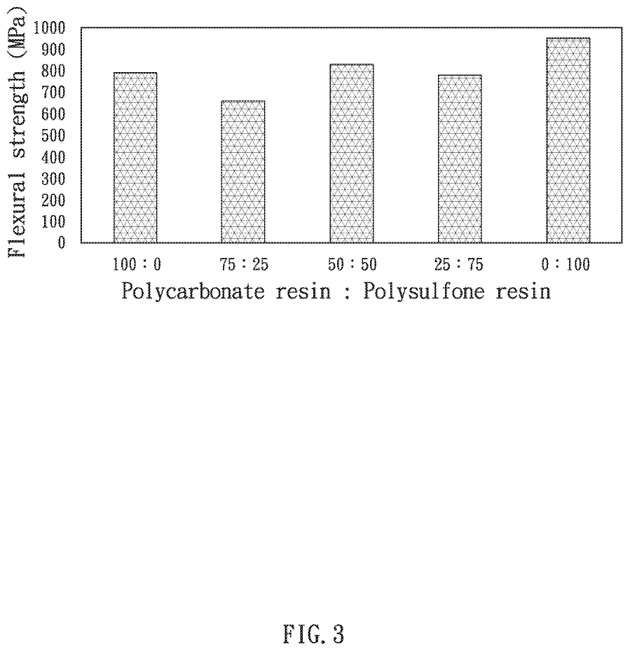

Also, referring to FIG. 2, FIG. 3, and Table 5, according to the flexural modulus and flexural strength of the composite tested by the ASTM international standard organization, the flexural modulus and the flexural strength of the composite corresponding to the polysulfone resin solution are 60 Gpa and 950 MPa, respectively, and the flexural modulus and the flexural strength of the composite corresponding to the polycarbonate resin solution are 53 GPa and 789 MPa. However, when the blending ratio of the polycarbonate resin to the polysulfone resin in the polymer blend are 50:50(1:1) and 75:25(3:1), respectively, the corresponding flexural modulus of the composite are significantly decreased to 50 GPa. More particularly, when the blending ratio of the polycarbonate resin to the polysulfone resin in the polymer blend is 75:25(3:1), the corresponding flexural strength of the matrix is decreased to 659 GPa. In comparison, when the blending ratio of the polycarbonate resin to the polysulfone resin in the polymer blend is 25:75(1:3), the corresponding flexural modulus of the composite is 56 GPa, which is between the flexural modulus of the composite with only the polycarbonate resin and the flexural modulus of the composite with only the polysulfone resin, and the corresponding flexural strength is 780 MPa. Clearly, the content of the polycarbonate resin in the polymer blend is inversely proportional to the flexural modulus.

It is proved by the experiments that when the blending ratio of the polycarbonate resin to the polysulfone resin in the polymer blend is 25:75(1:3) in the embodiment of the present invention, the groups of the polycarbonate and the groups of the polysulfone are stably compatible with each other. The glass transition temperature of the polymer blend is remarkably increased compared to the polycarbonate resin, further achieving a high-temperature resistance. The flexural modulus of the composite is correspondingly increased compared to the polycarbonate resin, such that the mechanical properties of the composite are improved.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A polymer blend containing polycarbonate and polysulfone, comprising:
a polysulfone resin;
a polycarbonate resin; and
a solvent for dissolving the polycarbonate resin and the polysulfone resin,
wherein a blending ratio of the polycarbonate resin to the polysulfone resin in the polymer blend ranges from 1:3 to 3:1; and the solvent is a polar aprotic solvent selected from the group consisting of N-methyl pyrrolidone, dimethyl sulfoxide, dimethyl acetamide, dimethyl formamide, cyclopentanone, dichloromethane, and a combination thereof.

2. The polymer blend of claim 1, wherein a total weight percentage of the polycarbonate resin and the polycarbonate resin accounts for 20% to 60% of the polymer blend.

3. The polymer blend of claim 2, wherein the total weight percentage of the polycarbonate resin and the polycarbonate resin accounts for 40% of the polymer blend.

4. The polymer blend of claim 1, wherein the blending ratio of the polycarbonate resin to the polysulfone resin is 1:3.

5. The polymer blend of claim 1, wherein a total solid content of the polycarbonate resin and the polysulfone resin in the solvent accounts for 30% of the polymer blend.

6. A composite containing the polymer blend of claim 1, further comprising a fiber reinforcement, wherein the fiber reinforcement is dipped in the polymer blend, and placed in the environment with a temperature from 170° C. to 300° C. for solidifying the polycarbonate resin and the polysulfone resin thereon.

7. (canceled)

8. (canceled)
